(19) United States
(12) Patent Application Publication
(10) Pub. No.: US 2025/0157351 A1
(43) Pub. Date: May 15, 2025

(54) USING DOMAIN EXPERTISE SCORES FOR SELECTION OF ARTIFICIAL INTELLIGENCE (AI) CHATBOTS AND A RELATIVELY BEST ANSWER

(71) Applicant: International Business Machines Corporation, Armonk, NY (US)

(72) Inventors: Jun Su, Beijing (CN); Yang Liang, Beijing (CN); Su Liu, Austin, TX (US); Michael Davis, Chesterfield, MO (US)

(21) Appl. No.: 18/388,452

(22) Filed: Nov. 9, 2023

(51) Int. Cl. G09B 3/02

(52) U.S. Cl. CPC G09B 3/02

(57) ABSTRACT

A computer-implemented method, according to one embodiment, includes obtaining a plurality of answers to a chatbot question. The answers are generated by different AI chatbots. The method further includes analyzing the answers to determine updated first domain expertise scores of the AI chatbots, and selecting, based on the updated first domain expertise scores, one of the answers. The selected answer are caused to be provided to a first user device. A computer program product, according to another embodiment, includes a computer readable storage medium having program instructions embodied therewith. The program instructions are readable and/or executable by a computer to cause the computer to perform any combination of features of the foregoing methodology.

### BACKGROUND

The present invention relates to chatbots, and more specifically, this invention relates to using domain expertise scores for selection of AI chatbots and a relatively best answer from a plurality of answers generated by the selected AI chatbots.

AI chatbots are relatively intelligent virtual agents designed to simulate human-like conversations. These AI chatbots are designed to engage in natural language conversations with users and provide automated responses. In many use cases, AI chatbots applications incorporate a graphical user interface that allows users to enter questions or other text input data into a chat box, which is processed and returns a chat box with some sort of response, e.g., an answer to the user's question. These chat boxes are typically arranged in a dialogue thread similar to a text message thread between two user devices. This creates an appearance as if the users are chatting with another person, while in actuality, the users are conversing with one or more computer devices.

### SUMMARY

A computer-implemented method, according to one embodiment, includes obtaining a plurality of answers to a chatbot question. The answers are generated by different AI chatbots. The method further includes analyzing the answers to determine updated first domain expertise scores of the AI chatbots, and selecting, based on the updated first domain expertise scores, one of the answers. The selected answer are caused to be provided to a first user device.

A computer program product, according to another embodiment, includes a computer readable storage medium having program instructions embodied therewith. The program instructions are readable and/or executable by a computer to cause the computer to perform any combination of features of the foregoing methodology.

A system, according to another embodiment, includes a processor, and logic integrated with the processor, executable by the processor, or integrated with and executable by the processor. The logic is configured to perform any combination of features of the foregoing methodology.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an infrastructure, in accordance with one embodiment of the present invention.

FIG. 4 is a flowchart of a method, in accordance with one embodiment of the present invention.

FIGS. 5A-5F depict snapshots of the progression of an analysis of potential answers generated by AI chatbots, in accordance with several embodiments of the present invention.

FIG. 6 depicts a distribution of different expertise scores of different AI chatbots, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using domain expertise scores for selection of AI chatbots and a relatively best answer from a plurality of answers generated by the selected AI chatbots.

In one general embodiment, a computer-implemented method includes obtaining a plurality of answers to a chatbot question. The answers are generated by different AI chatbots. The method further includes analyzing the answers to determine updated first domain expertise scores of the AI chatbots, and selecting, based on the updated first domain expertise scores, one of the answers. The selected answer are caused to be provided to a first user device.

In another general embodiment, a computer program product includes a computer readable storage medium having program instructions embodied therewith. The program instructions are readable and/or executable by a computer to cause the computer to perform any combination of features of the foregoing methodology.

In another general embodiment, a system includes a processor, and logic integrated with the processor, executable by the processor, or integrated with and executable by the processor. The logic is configured to perform any combination of features of the foregoing methodology.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as expertise score determination code of block 150 for using domain expertise scores for selection of AI chatbots and a relatively best answer from a plurality of answers generated by the selected AI chatbots. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

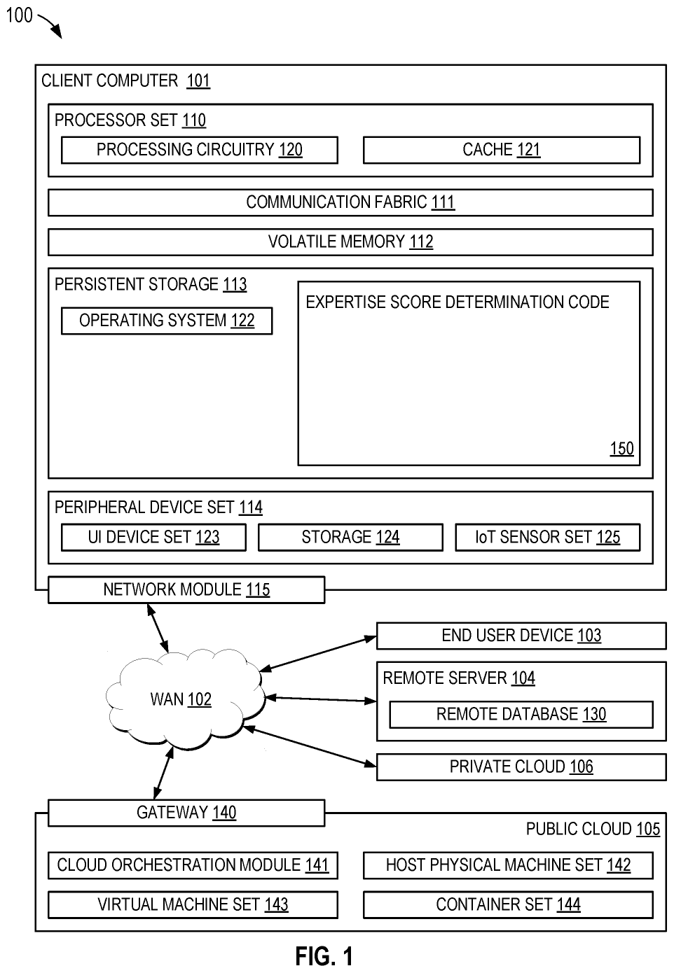

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, AI chatbots are relatively intelligent virtual agents designed to simulate human-like conversations. These AI chatbots are designed to engage in natural language conversations with users and provide automated responses. In many use cases, AI chatbots applications incorporate a graphical user interface that allows users to enter questions or other text input data into a chat box, which is processed and returns a chat box with some sort of response, e.g., an answer to the user's question. These chat boxes are typically arranged in a dialogue thread similar to a text message thread between two user devices. This creates an appearance as if the users are chatting with another person, while in actuality, the users are conversing with one or more computer devices.

Although AI chatbots can be useful for answering user questions, the capabilities and qualities of AI chatbots can vary significantly based on factors such as training data, model architectures, specific use cases, etc. As a result, users often face challenges in determining the reliability and accuracy of the answers provided by individual AI chatbots. Moreover, AI models are sometimes probabilistic systems in that they may sometimes generate different responses for the same input. This introduces further complexities in evaluating the performance of an AI chatbot.

The adoption of AI chatbots in various use cases has relatively improved user interactions and streamlined information access. However, challenges remain in ensuring the accuracy and reliability of the answers provided by AI chatbots. Several factors contribute to these challenges, prompting the need for a comprehensive approach to address them. For example, a first of these factors includes varying AI chatbot capabilities as different AI chatbots are built on diverse model architectures and trained using distinct datasets. As a result, the abilities of different AI chatbots being able to understand and respond to user queries can vary significantly. For example, some AI chatbots may excel in specific domains, while others may struggle with understanding more nuanced or complex language patterns.

For context, these “domains” may be defined as a predominate subject matter and/or context of text entry data, e.g., text that is entered into a chatbot text entry window. Illustrative examples of domains are described elsewhere below.

Ambiguity and uncertainty are additional factors that contribute to the challenges noted above. More specifically, AI models, and particularly relatively large language models, may exhibit uncertainty in their predictions, leading to different responses for the same input. This results in some users receiving inconsistent answers, which ultimately creates confusion and reduces user confidence in the reliability of AI chatbots. The factors additionally include a lack of transparency in that AI chatbot providers may not always explicitly disclose the strengths and limitations of their chatbots. This lack of transparency creates a challenge for users to know the scope of a given AI chatbot's knowledge and expertise.

Potential biases is another factor that contributes to the challenges noted above. The training data used to develop AI chatbots may contain biases present in the source data. Biases in responses can lead to inaccurate or unfair information being provided to users, affecting their overall experience. User engagement and trust is another of these factors. Users are more likely to engage with AI chatbots and trust responses of the AI chatbots when the users consistently receive accurate and relevant information. Inaccurate answers can erode user trust and reduce the effectiveness of AI-chatbots in their intended applications. Personalization and context is another of the factors. Users often expect personalized responses that consider their individual preferences and context. However, achieving personalized and contextually relevant answers can be challenging, especially when AI chatbots lack the ability to adapt to specific user needs.

Based on the factors listed above, there is a longstanding need within the field of conventional AI chatbots for defining techniques that ensure the accuracy and reliability of AI chatbot answers across all domains. Currently, conventional AI chatbots fail to verify and evaluate answers from AI Chatbots on the fly. The techniques of embodiments and approaches described herein enable selection of artificial intelligence (AI) chatbot answers based on domain expertise scores. More specifically, in some of these embodiments and approaches, a relatively “best answer” is able to be identified and selected from multiple AI Chatbot candidate answers.

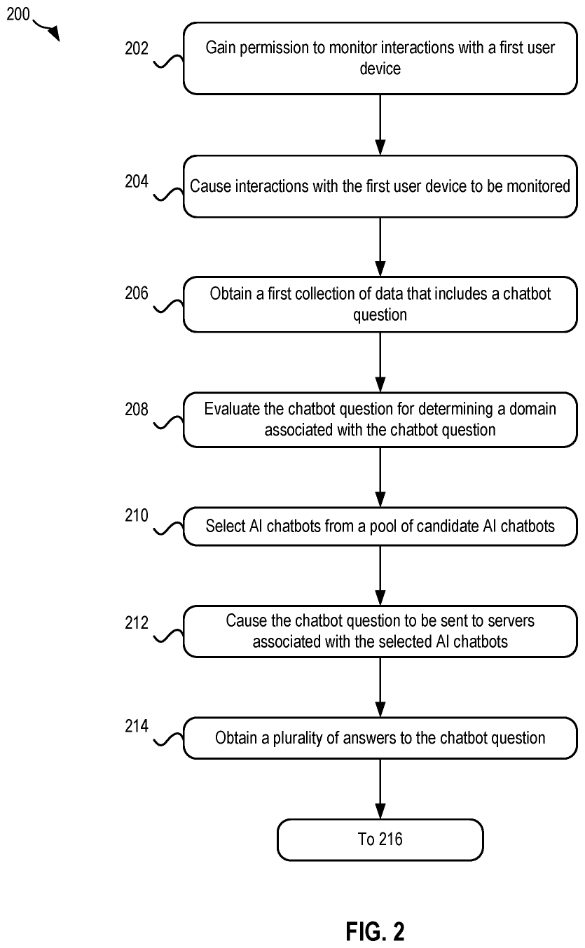

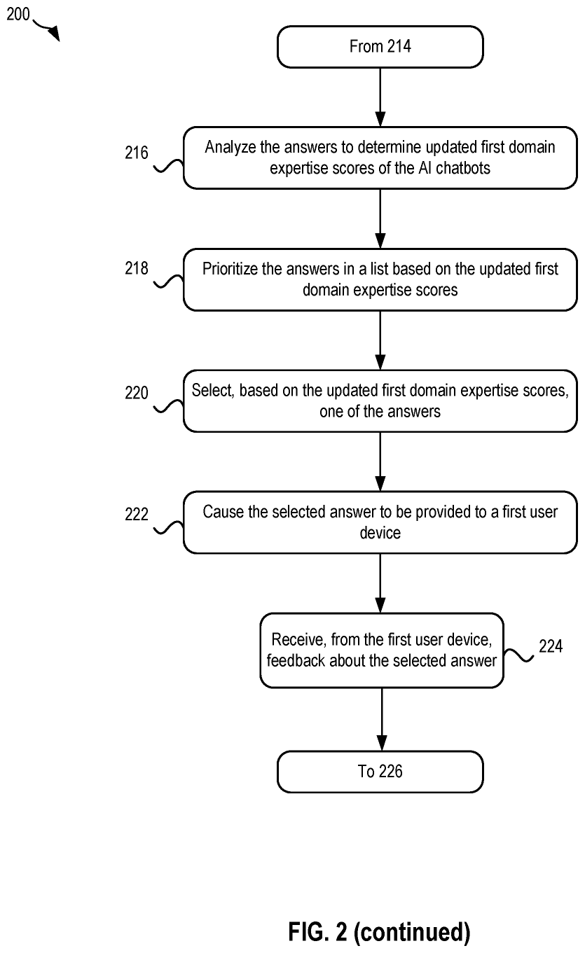

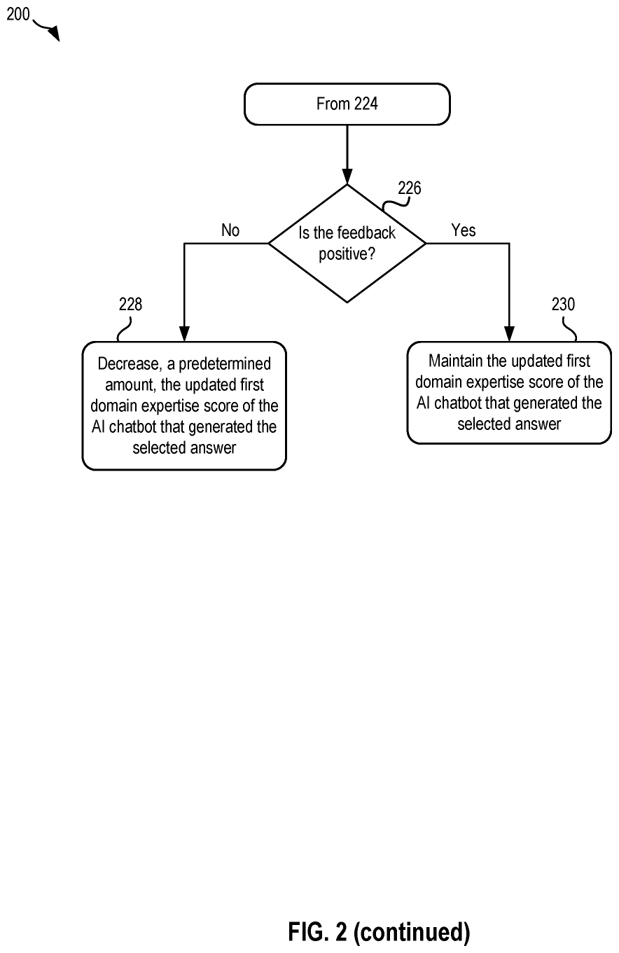

Now referring to FIG. 2, a flowchart of a method 200 is shown according to one embodiment. The method 200 may be performed in accordance with the present invention in any of the environments depicted in FIGS. 1-6, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may be performed in a network environment in which one or more user devices, e.g., laptops, tablets, phones, etc., are configured to host a predetermined AI chatbot application. For example, the AI chatbot application may generate AI chatbot entry boxes that are displayed on a display of at least one of the user devices. This way, a user may enter text entry data onto one of the user devices, e.g., enter a question that is to be answered. In some approaches, a user device may be configured to perform operations of method 200. More specifically, the user device may be configured to analyze a chatbot question, interact with a server of AI chatbots and select, based on domain expertise scores, one of a plurality of candidate chatbot answers determined by the AI chatbots.

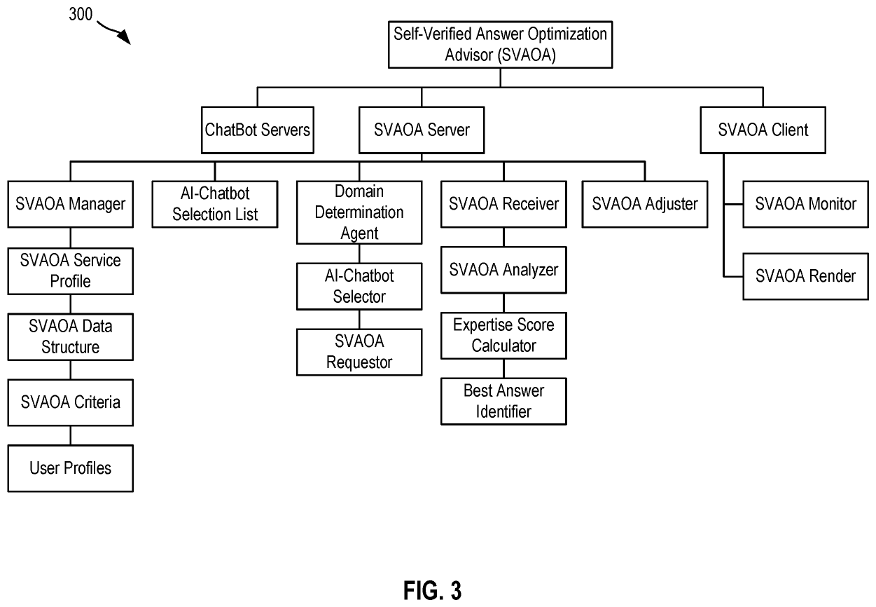

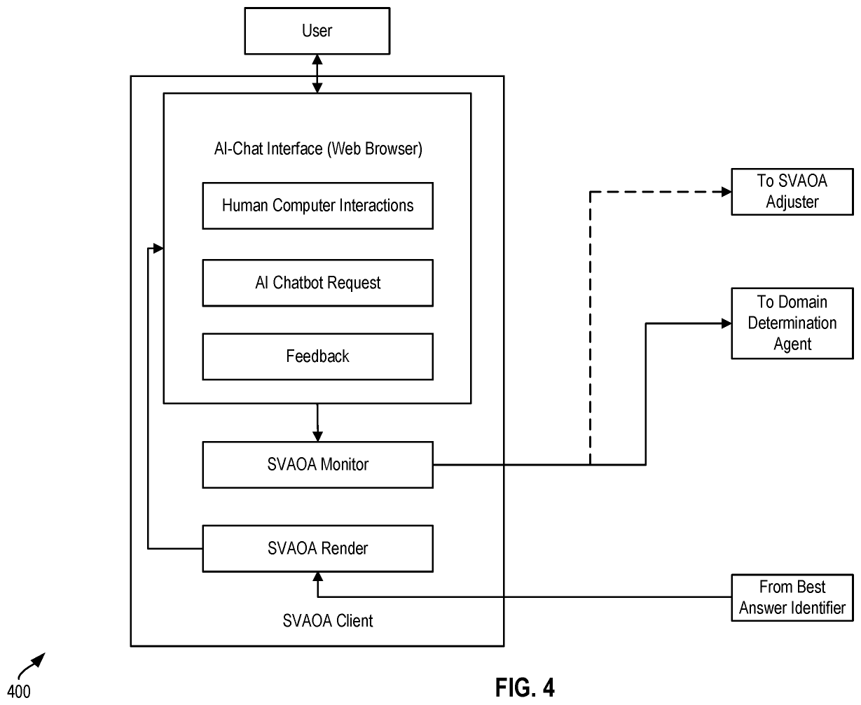

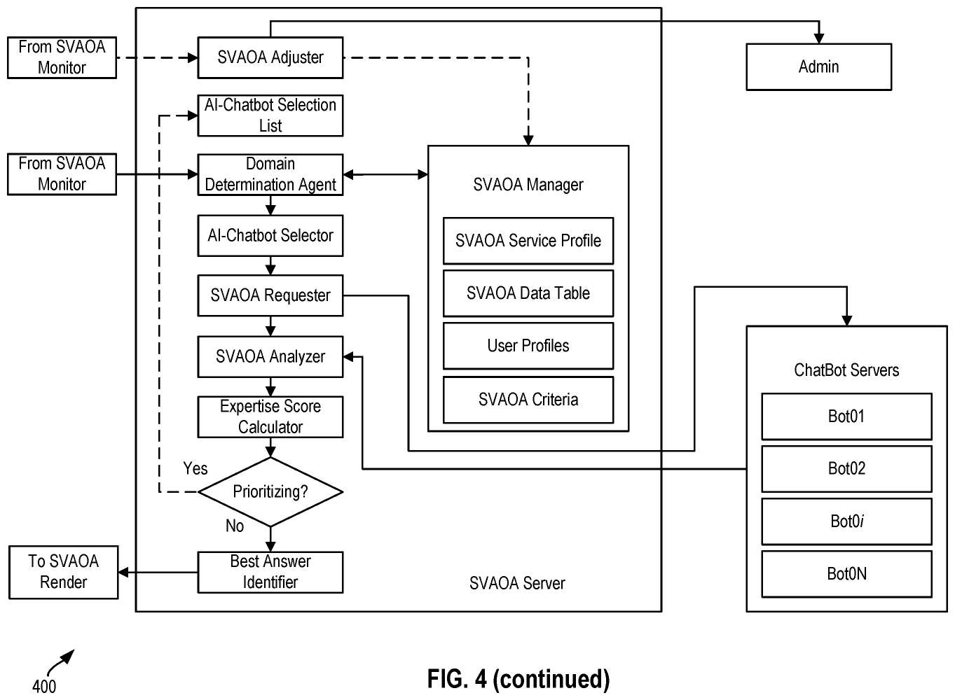

In contrast, in some other approaches, the operations of method 200 may be performed by a server that is in communication with one or more of the user devices. Using a server to perform the operations of method 200 rather than a user device may be useful where the user devices do not have a sufficient amount of processing resources for performing the analysis operations described herein. Accordingly, in such approaches, the chatbot question may be output by the user device to the server for performing the analysis. It should be noted that an infrastructure of components associated with such a network environment is described in further detail elsewhere herein, e.g., see FIGS. 3-4.

It should be noted that any monitoring of user actions and/or behavior described herein is preferably only obtained subsequent to gaining permission from the associated users. For example, operation 202 includes gaining permission to monitor interactions with a first of the user devices. The permission is preferably explicitly granted, and may be revoked by the associated users at any time and for any reason.

Operation 204 includes causing interactions with the first user device to be monitored. In some approaches, causing interactions with the first user device to be monitored may include instructing the first device to perform the monitoring. In some other approaches, causing interactions with the first user device to be monitored includes the first user engaging in a type of text recording that would become apparent to one of ordinary skill in the art after reading the descriptions herein. The interactions with the first user device may depend on the approach. For example, in some approaches, interactions with the first user device may include text being input on the first device. Accordingly, in one or more of such approaches, the monitoring includes recording text entry data that is input using a selection tool and/or keyboard paired with the first device. The text input on the first device may, in some approaches, be text entry data that includes a question that is entered into a chatbot interface of the first user device, e.g., a portal window for typing questions into in order to have the questions answered by an AI service.

A first collection of data is obtained as a result of the monitoring being caused to be performed, e.g., see operation 206. The obtained first question of data preferably includes a first chatbot question that a user that entered the first chatbot question on the first user device would like to be answered.

Operation 208 includes evaluating the chatbot question for determining a domain associated with the chatbot question. In some approaches, natural language processing techniques that would become apparent to one of ordinary skill in the art after reading the descriptions herein may be used to parse the chatbot question to identify at least a first domain associated with the chatbot question. Accordingly, it should be noted that although more than one domain may be determined during the evaluation performed, for purposes of an example and descriptions herein, the first domain is determined to be associated with the chatbot question during the evaluation of the first chatbot question.

As mentioned elsewhere above, domains may be defined as a predominate subject matter and/or context of text entry data, e.g., text that is entered into a chatbot text entry window as a question. Illustrative examples of domains are described below. In some approaches, a domain of at least some of the AI chatbots includes general knowledge and/or trivia. In some approaches, a domain may be determined to be general knowledge and/or trivia in response to a determination that an evaluation of the AI chatbot question identifies, e.g., questions about historical facts, geographical information, famous personalities, a predetermined number of general facts, etc. In some other approaches, a domain of at least some of the AI chatbots includes science and technology. In some approaches, a domain may be determined to be science and technology in response to a determination that an evaluation of the AI chatbot question identifies, e.g., inquiries related to scientific concepts, inquiries related to physics, inquiries related to chemistry, inquiries related to biology, inquiries related to astronomy, inquiries related to technological advancements, etc. In some other approaches, a domain of at least some of the AI chatbots includes mathematics and/or calculations. In some approaches, a domain may be determined to be mathematics and/or calculations in response to a determination that an evaluation of the AI chatbot question identifies questions involving, e.g., arithmetic, algebra, geometry, statistics, mathematical problem solving, etc. In some other approaches, a domain of at least some of the AI chatbots includes language and/or linguistics. In some approaches, a domain may be determined to be language and/or linguistics in response to a determination that an evaluation of the AI chatbot question identifies queries involving, e.g., grammar, vocabulary, word meanings, language translation, linguistic rules, etc. In some other approaches, a domain of at least some of the AI chatbots includes entertainment and/or pop culture. In some approaches, a domain may be determined to be entertainment and/or pop culture in response to a determination that an evaluation of the AI chatbot question identifies, e.g., movies, music, celebrities, television shows, books, popular culture references, etc. In some other approaches, a domain of at least some of the AI chatbots includes health and/or medicine. In some approaches, a domain may be determined to be health and/or medicine in response to a determination that an evaluation of the AI chatbot question identifies text detailing, e.g., medical conditions, symptoms, treatments, nutrition, general health advice, etc. In some other approaches, a domain of at least some of the AI chatbots includes sports and/or athletics. In some approaches, a domain may be determined to be sports and/or athletics in response to a determination that an evaluation of the AI chatbot question identifies text detailing, e.g., sports events, athletes, rules of games, sports-related statistics, etc. In some other approaches, a domain of at least some of the AI chatbots includes food and/or cooking. In some approaches, a domain may be determined to be food and/or cooking in response to a determination that an evaluation of the AI chatbot question identifies text detailing, e.g., recipes, cooking techniques, food ingredients, dietary preferences, etc. In some other approaches, a domain of at least some of the AI chatbots includes travel and/or geography. In some approaches, a domain may be determined to be travel and/or geography in response to a determination that an evaluation of the AI chatbot question identifies text detailing, e.g., travel destinations, tourist attractions, travel tips, geographical information, etc. In some other approaches, a domain of at least some of the AI chatbots includes history and events. In some approaches, a domain may be determined to be history and events in response to a determination that an evaluation of the AI chatbot question identifies text detailing, e.g., historical events, timelines, significant figures, historical periods, etc. In some other approaches, a domain of at least some of the AI chatbots includes art and literature. In some approaches, a domain may be determined to be art and literature in response to a determination that an evaluation of the AI chatbot question identifies text detailing, e.g., famous artworks, literature genres, authors, literary analysis, etc. In some other approaches, a domain of at least some of the AI chatbots includes environmental science. In some approaches, a domain may be determined to be environmental science in response to a determination that an evaluation of the AI chatbot question identifies text detailing, e.g., ecology, climate change, conservation, environmental issues, etc. In some other approaches, a domain of at least some of the AI chatbots includes computer programming. In some approaches, a domain may be determined to be computer programming in response to a determination that an evaluation of the AI chatbot question identifies text detailing, e.g., coding, programming languages, software development, technical problem-solving, etc. In some other approaches, a domain of at least some of the AI chatbots includes finance and economics. In some approaches, a domain may be determined to be finance and economics in response to a determination that an evaluation of the AI chatbot question identifies text detailing, e.g., personal finance, economic principles, stock market, financial planning, etc. In some other approaches, a domain of at least some of the AI chatbots includes politics and current affairs. In some approaches, a domain may be determined to be politics and current affairs in response to a determination that an evaluation of the AI chatbot question identifies text detailing, e.g., political events, government policies, current news topics, etc. In some other approaches, a domain of at least some of the AI chatbots includes social sciences. In some approaches, a domain may be determined to be social sciences in response to a determination that an evaluation of the AI chatbot question identifies text detailing, e.g., psychology, sociology, anthropology, human behavior, etc. In some other approaches, a domain of at least some of the AI chatbots includes education and learning. In some approaches, a domain may be determined to be education and learning in response to a determination that an evaluation of the AI chatbot question identifies text detailing, e.g., study tips, educational resources, learning strategies, academic subjects, etc. In some other approaches, a domain of at least some of the AI chatbots includes mythology and folklore. In some approaches, a domain may be determined to be mythology and folklore in response to a determination that an evaluation of the AI chatbot question identifies text detailing, e.g., myths, legends, folklore, cultural stories, etc. In some other approaches, a domain of at least some of the AI chatbots includes fashion and style. In some approaches, a domain may be determined to be fashion and style in response to a determination that an evaluation of the AI chatbot question identifies text detailing, e.g., fashion trends, clothing, beauty, personal style, etc. In some other approaches, a domain of at least some of the AI chatbots includes parenting and childcare. In some approaches, a domain may be determined to be parenting and childcare in response to a determination that an evaluation of the AI chatbot question identifies text detailing, e.g., parenting advice, child development, childcare tips, etc. In some preferred approaches, the domains include geography, language, mathematics, science, and programming.

A plurality of AI chatbots for analyzing the chatbot question are selected from a pool of candidate AI chatbots, e.g., see operation 210. The pool of candidate AI chatbots may be at least some, and in some approaches, be all of the AI chatbots of a predetermined AI chatbot server. In some other approaches, the pool of candidate AI chatbots may include at least some AI chatbots from different AI chatbot servers. In some preferred approaches, the AI chatbots are selected from the pool of candidate AI chatbots based on expertise scores that the AI chatbots have for one or more different domains. Each of the AI chatbots may have a plurality of expertise scores for a plurality of different domains, e.g., such as the first domain that is associated with the chatbot question. For context, each of these “expertise scores” indicate an accuracy that an associated one of the AI chatbots currently has answering chatbot questions related to a domain of the expertise score. For example, it may be assumed that a first AI chatbot that has an expertise score of 88% for the first domain has previously been able (based on past performance that the current expertise score is calculated based on) to relatively more accurately answer chatbot questions based on the first domain than a second AI chatbot that has an expertise score of 54% for the first domain. It should be noted that preferred techniques for calculating and updating such expertise scores for the AI chatbots is described elsewhere below.

In some other approaches, the AI chatbots may be selected from the pool of candidate AI chatbots based on the selected AI chatbots having the relatively highest current expertise scores for a determined domain of the chatbot question. In some approaches, user preferences may be analyzed to determine a preferred number of AI chatbots to select. Accordingly, the preferred number of AI chatbots may be selected as the AI chatbots having the relatively highest current expertise scores. In some other approaches, a plurality of domains may be considered during the selection process. For example, NLP may be used to determine a plurality of domains that are related to the chatbot question. In one or more of such approaches, the plurality of domains includes the first domain. Furthermore, consideration of the plurality of domains for a given one of the AI chatbots may, in one or more of such approaches, include averaging the different current domain expertise scores associated with the considered domains. The AI chatbots having the relatively greatest average current domain scores may be selected.

The AI chatbots are, in some approaches, selected in response to a determination that the AI chatbots currently have first domain expertise scores that exceed or match a predetermined threshold, e.g., 25%, 50%, 75%, 90%, etc. At least some of the AI chatbots of the pool of candidate AI chatbots may have first domain expertise scores that do not exceed the predetermined threshold. In some approaches, the AI chatbots of the pool of candidate AI chatbots that have first domain expertise scores that do not exceed the predetermined threshold are excluded from the selected group of AI chatbots. This exclusion preserves processing potential that would otherwise be expended by having these AI chatbots, that are known to have a relative expertise in the first domain, process the AI question. In contrast, in some approaches, by ensuring that the AI chatbots that are selected have first domain expertise scores that at least match the predetermined threshold, the AI chatbots that are used for answering the chatbot question are vetted to be the relatively most qualified AI questions of the pool of candidate AI chatbots for answering the chatbot question.

The AI chatbots may additionally and/or alternatively be selected from the pool of candidate AI chatbots based on user preferences, in some approaches. For example, in one or more of such approaches, the AI chatbots are selected based on preference information of the user that entered the chatbot question on the first user device. Incorporation of user preferences identified in obtained preference information into the selection of the AI chatbots ensures that the chatbot question is not otherwise processed by AI chatbots and/or servers that the user does not want to use for processing the chatbot question.

Operation 212 includes causing the chatbot question to be sent to servers associated with the selected AI chatbots. In some approaches, the chatbot question is sent to the servers associated with the selected AI chatbots with an instruction to have the selected AI chatbots to generate answers to the chatbot question.

Operation 214 includes obtaining a plurality of answers to the chatbot question. In some preferred approaches, each of the answers are generated by one of the different AI chatbots selected in operation 210. However, in some other approaches, at least two of the answers may be generated by a first of the AI chatbots and at least one other answer may be generated by a second of the AI chatbots. The answers may, in some approaches, be obtained as a packet that is received from servers associated with the AI chatbots. In some other approaches, the answers are obtained in response to a request being issued to the selected AI chatbots and/or servers associated with the selected AI chatbots. In some other approaches, the answers are obtained by accessing a predetermined database.

The answers are, in some preferred approaches, analyzed to determine updated first domain expertise scores of the AI chatbots, e.g., see operation 216. In other words, in one or more of such approaches, contents of the answers are analyzed to determine how to update the first domain expertise scores of the AI chatbots. Analyzing the answers to determine the updated first domain expertise scores of the AI chatbots may, in some approaches, include performing one or more calculations. For example, in some approaches, method 200 includes calculating relevance-consistency values for at least some of, and preferably each of, the answers. For context, the relevance-consistency value for a given one of the answers indicates an extent of similarity that the given answer has with the other answers. This means that, in some approaches, answers with a relatively greater relevance-consistency value are similar to relatively more of the other answers than other answers with relatively lesser relevance-consistency values. These techniques may be useful for identifying outlier answers that may be considered not on-point, as will be described elsewhere below.

According to some approaches, a relevance-consistency value may be a difference of a predetermined threshold value and a sum different answer value. An equation that may be used to represent these mathematical relationships is illustrated below, e.g., see Equation (1).

$$RC = TH - SUM ( Different Answer \% ) \qquad Equation ( 1 )$$

In Equation (1), the variable RC represents the relevance-consistency value that is equal to a difference of a predetermined threshold value, e.g., see variable TH, and the sum different answer value, e.g., see SUM (Different Answer %). For context, the sum different answer value characterizes, for a given one of the answers, a percentage of the answers that the given answer differs from. For example, in one approach, an assumption may be made that there are four answers, and that the first answer generated by a first AI chatbot, the second answer generated by a second AI chatbot, and the third answer generated by a third AI chatbot exactly match. Furthermore, in this example, an assumption may be made that the fourth answer generated by a fourth AI chatbot does not match any of the other answers. The sum different answer value for the first answer in this example is 25%, e.g., which may be represented by a value of 0.25, based on the first answer being different than only the fourth answer, where the fourth answer represents only 25% of the total answers. The sum different answer value for the second answer in this example is also 25%, e.g., which may be represented by a value of 0.25, and the sum different answer value for the third answer in this example is also 25%, e.g., which may be represented by a value of 0.25, for the same reason as the first answer. In contrast, the sum different answer value for the fourth answer in this example is 75%, e.g., which may be represented by a value of 0.75, because the fourth answer is different than the other three answers.

The updated first domain expertise score of a given one of the AI chatbots may, in some preferred approaches, be calculated as a sum of a first predetermined variable and a second predetermined variable. In one preferred approach, the first predetermined variable is a current first domain expertise score of the given AI chatbot. For context, the current first domain expertise score of the given AI chatbot may, in some approaches, be a most previously generated first domain expertise score of the given AI chatbot, e.g., in a most recently performed iteration of analyzing answers. However, in some other approaches, at least some of the AI chatbots may be newly launched, and therefore these AI chatbots may have never previously generated an answer to a chatbot question. Accordingly, in some approaches, at least some AI chatbots may initially be assigned default expertise scores for at least the first domain. These default values may thereafter be ongoingly updated based on the analyzation of answers of the AI chatbots. Furthermore, the second predetermined variable may, in some approaches, be a product of the current first domain expertise score of the given AI chatbot and the calculating relevance-consistency value of the given AI chatbot. For context, an equation is provided below for determining updated first domain expertise scores of a given one of the AI chatbots, e.g., see Equation (2).

$$ES 2 = ED 1 + ( ES 1 / 100 ) * RC \qquad Equation ( 2 )$$

In Equation (2), the variable ES2 represents an updated first domain expertise score of a given AI chatbot, the variable ES1 represents a current first domain expertise score of the given AI chatbot, and the variable RC represents the relevance-consistency value that may be calculated using techniques described elsewhere above, e.g., see Equation (1).

It should be noted that although some approaches above describe calculating domain expertise scores of the first domain, the equations and techniques described herein may additionally and/or alternatively be used to determine calculating domain expertise scores with respect to any one or more domains.

Operation 218 includes optionally prioritizing the answers in a list based on the updated first domain expertise scores. In some approaches, the answers are prioritized in a descending order based on the updated first domain expertise scores, e.g., an answer of an AI chatbot having a relatively highest updated first domain expertise score is prioritized relatively highest and therefore placed at the top of the list, an answer of an AI chatbot having a relatively lowest updated first domain expertise score is prioritized relatively lowest and therefore placed at the bottom of the list, etc. AI chatbots having relatively lower updated first domain expertise scores are relatively lower because these answers may be considered to be not on-point. This is because these outlier answers may be assumed to be based on the associated AI chatbots not having a relatively great enough expertise in the first domain. This prioritization scheme allows the answer of the AI chatbot having the relatively highest updated first domain expertise score to be readily identifiable.

Operation 220 includes selecting, based on the updated first domain expertise scores, one of the answers. In some preferred approaches, the selected answer is selected based on having the relatively highest updated first domain expertise score in the list, and therefore may, in some approaches, be considered the relatively “best answer” of the plurality of answers that are generated by the selected AI chatbots. In some other approaches, the selected answer is selected based on having the relatively highest updated first domain expertise score in the list for a previous number of past analyzed answers, e.g., an answer of a given one of the AI chatbots that has for the last three answer analyzation iterations had the relatively highest updated first domain expertise score, an answer of a given one of the AI chatbots that has for the last two answer analyzation iterations had the relatively highest updated first domain expertise score, an answer of a given one of the AI chatbots that has for the last ten answer analyzation iterations had the relatively highest updated first domain expertise score, etc.

For context, selection of an answer based on the answer having the relatively highest updated domain expertise score in the list for a given domain may ensure that an answer that is ultimately returned to a user that input the chatbot question is relatively more on point than any other answer that would otherwise be returned to the user. An amount of processing resources that are consumed in answering the chatbot question is therefore ultimately reduced over time as a result of the operations described herein. This is because processing operations that would otherwise be performed to correct an inaccurate answer that is returned to the first user device are avoided. For example, in some examples described elsewhere above, the fourth answer may be identified to be determined by an AI chatbot having a relatively low updated first domain expertise score, and therefore the fourth answer is not selected for returning to the first user device. Based on this exclusion, processing operations that would otherwise be performed in the network environment in order to account for the answer being inaccurate, e.g., user feedback, user research on online search engines, etc., are avoided.

Operation 222 includes causing the selected answer to be provided to a first user device. The first user device is preferably a user device from which the chatbot question originates and/or a user device that is configured to display the selected answer for a user that sought the chatbot question to be answered. In some approaches in which method 200 is performed by the first user device, causing the selected answer to be returned to the first user device may include adding an instruction in the chatbot questions sent to the chatbot servers to return the answers to the first user device. In some other approaches in which method 200 is performed by another device, e.g., a server that is different than the first user device and that is different than the servers associated with the AI chatbots, causing the selected answer to be returned to the first user device may include outputting the selected answer to the first user device.

In some approaches, causing the selected answer to be provided to the first user device includes rendering the selected answer according to a predetermined sentence structure, and outputting the rendered selected answer to the first user device. For example, in some approaches, NLP may be used to determine that at least some of the selected answer is not readable user text. In response to such a determination, techniques that would become apparent to one of ordinary skill in the art may be used to render the selected answer into readable user text, e.g., sentence structuring techniques may be applied to render the selected answer to readable user text. The rendering allows the selected answer to be delivered to the first user device in a form that can be presented to the user that input at least some of the chatbot question text into a chatbot interface of the first user device. This rendering reduces the amount of data that is ultimately transmitted to the first user device in the event that the rendering cuts out at least some of the selected answer that is determined to not be of the form that can be presented to the user. Furthermore, this rendering mitigates device processing operations that would otherwise potentially be performed in order to clarify a meaning of the selected answer, e.g., a request for clarification returned by the first user device.

In some approaches, method 200 includes receiving and using user feedback in order to relatively refine the accuracy of answers produced by AI chatbots during subsequent iterations of method 200. For example, operation 224 includes receiving, from the first user device, feedback about the selected answer. In order to determine whether thresholds used in the process of generating the answers should be adjusted, e.g., based on the updated first domain expertise scores of the AI chatbots resulting in one or more instances of dissatisfactory feedback, method 200 may include determining whether the feedback is positive feedback, e.g., see decision 226. Determining whether the feedback is positive feedback may include using NLP techniques to parse the feedback about the selected answer to determine whether the feedback about the selected answer includes one or more predetermined words associated with negative feedback, e.g., unhappy, disapprove, upsetting, what does this mean, I do not understand, etc. In contrast, determining whether the feedback is positive feedback may additionally and/or alternatively include using NLP techniques to parse the feedback about the selected answer to determine whether the feedback about the selected answer includes one or more predetermined words associated with positive feedback, e.g., happy, yay, approve, great, I understand, perfect, thank you, etc. In response to a determination, e.g., see “No” logical path of decision 226, that the feedback is not positive feedback, e.g., is a complaint, the consumer is dissatisfied, etc., method 200 includes optionally decreasing, a predetermined amount, the updated first domain expertise score of the AI chatbot that generated the selected answer, e.g., see operation 228. Decreasing the updated first domain expertise score of the AI chatbot that generated the selected answer may ensure that the AI chatbot that generated the selected answer is prioritized relatively less in a subsequent consideration of answers generated by the AI chatbot, e.g., based on the decreased first domain expertise score. In contrast, in response to a determination, e.g., see “Yes” logical path of decision 226, that the feedback is positive feedback, e.g., is a positive review, the consumer is satisfied, etc., method 200 optionally includes maintaining the updated first domain expertise score of the AI chatbot that generated the selected answer, e.g., see operation 230. For context, “maintaining” the updated first domain expertise score of the AI chatbot that generated the selected answer may, in some approaches, include not adjusting the updated first domain expertise score, and instead, using the updated first domain expertise score of the AI chatbot in a subsequent selection of obtained answers. In some other approaches, in response to the determination that the feedback is positive feedback, method 200 optionally includes rewarding the AI chatbot that generated the selected answer by increasing the updated first domain expertise score of the AI chatbot that generated the selected answer the predetermined amount, e.g., 1%, 5%, 10%, etc.

Operation 222 may additionally and/or alternatively include causing the answers that are not selected to not be returned to the first user device. For example, causing the answers that are not selected to not be returned to the first user device may include, e.g., discarding the answers that are not selected, excluding the answers that are not selected from a response that is output to the first user device, storing the answers that are not selected in a predetermined database, etc.

Various performance benefits are enabled as a result of implementing the techniques described herein in network environments that include AI chatbots. Although several of these performance benefits are described above throughout the operations of method 200, additional performance benefits are detailed below. For example, the operations described provide a self-verified answer optimization advisor that is enabled via an aggregated multiple AI-chatbots deployed on a human to computer interaction level. Furthermore, these techniques enable and integrate self-verification capabilities into an interface of an AI-chatbot in a host controller interface (HCI) level. It should be distinguished that, the techniques described herein enable an assessment of the quality and relevance of AI-chat answers in real time, which would not otherwise be possible by humans. This is because human analysis of answers would implement significant delays and errors that would otherwise increase an amount of processing operations that are performed in order to recover from such errors.

The techniques described herein furthermore reduce an amount of processing operations that are performed to answer a typical AI chatbot question. This is because conventional techniques route chatbot questions to a default AI chatbot while the techniques described herein leverage an ensemble of AI-chatbots with diverse expertise in different domains. Because conventional techniques fail to consider the relative expertise of chatbots that are caused to answer a question, additional processing resources are often expended in processing clarification requests from user devices. In sharp contrast, using the techniques described herein, personalized and contextually appropriate answers are ensured to be delivered. These techniques define self-optimization algorithms to fine-tune responses based on self-verification results for ensuring relatively high accuracy and relevance in answers that are returned to requesting user devices.

The techniques described herein furthermore enhance accuracy and reliability in the field of AI chatbots. More specifically, these techniques leverage self-verification algorithms to assess the quality of AI-chatbot responses, ensuring that users receive accurate and reliable information. By analyzing responses from multiple AI-chatbots, the ensemble approach enhances the likelihood of delivering correct answers. Personalized and contextually relevant responses are also enabled as a result of the techniques described herein. Through the aggregation of AI chatbots with diverse expertise, method 200 provides personalized responses tailored to a user's specific needs and preferences. This way users receive contextually appropriate answers that consider their individual requirements and/or preferences. User engagement and trust is also promoted by the techniques described herein. For example, by consistently delivering high quality and relevant responses, these techniques foster user engagement and build trust in the AI chatbot system. In turn, users are more likely to interact with the AI chatbot confidently, leading to increased user satisfaction within the field of AI chatbots. A relatively comprehensive knowledge base is also developed as a result of using multiple AI chatbots with different specializations. This comprehensive knowledge base covers a wide range of topics and domains and enables the AI chatbots to establish an ensemble to handle a diverse set of queries relatively effectively. Furthermore, adaptability and continuous learning is enabled by the techniques described herein. For example, the method techniques described herein facilitate continuous learning and adaptation of the AI chatbot ensemble. Through user feedback and updates in training data, performance of the ensemble is improved over time, staying up to date with the latest information.

Transparent and self-aware responses are also created using the techniques described herein. By incorporating self-verification capabilities, the AI-chatbot becomes relatively more self-aware of its own performance, e.g., the AI chatbot is caused to make relatively more accurate answers in response to receiving reward feedback. This transparency in answers returned to user devices allows users to understand the AI chatbot's confidence in the answers the AI chatbot generates and builds transparency in the decision making process of the AI chatbot. Biases are reduced and consistency is also established as a result of deploying the techniques described herein. By aggregating responses from different AI chatbots, the techniques described herein mitigate potential biases present in individual models. Furthermore, users receive consistent and objective answers, free from the influence of biases.

Optimization for relatively complex queries is another benefit enabled using the techniques described herein. The self-optimization algorithms described herein, e.g., see Equations (1)-(2), fine-tune responses based on self-verification of results. This in turn optimizes the answers generated by AI chatbots for relatively more complex and nuanced queries, which would otherwise be considered challenging for individual AI chatbots. Versatility and scalability is also enabled in the field of AI chatbots in that the techniques described herein are capable of handling various domains and accommodating additional AI chatbots with specialized expertise. This scalability allows the ensemble to adapt to diverse user needs and expanding knowledge domains. Real-time interactions are also able to be processed. More specifically, the techniques described herein facilitate real-time interactions, allowing users to receive prompt and reliable answers to their queries, which ultimately enhances the overall user experience when interacting with AI chatbots.

FIG. 3 depicts an infrastructure 300, in accordance with one approach. As an option, the present infrastructure 300 may be implemented in conjunction with features from any other approach listed herein, such as those described with reference to the other FIGS. Of course, however, such infrastructure 300 and others presented herein may be used in various applications and/or in permutations which may or may not be specifically described in the illustrative approaches listed herein. Further, the infrastructure 300 presented herein may be used in any desired environment.

It may be prefaced that the infrastructure 300 includes components associated with a network environment in which the operations of method 200 may be performed. The infrastructure 300 includes a self-verified answer optimization advisor (SVAOA) that may be deployed via an application of a predetermined server, e.g., see SVAOA server, or a predetermined user device, e.g., see SVAOA client. The SVAOA may interact with a plurality of chatbot servers (“ChatBot Servers”) for answering an obtained chatbot question. In some approaches, the SVAOA server may be and/or include a server application that is configured to receive all requests from SVAOA clients, and to send the requests to selected Chatbot Servers. The SVAOA server may, additionally and/or alternatively be configured to receive and analyze all answers obtained from the requested Chatbot Servers and identify the best answer using the techniques described elsewhere herein, e.g., see method 200. The SVAOA server may add a middle layer between AI-Chatbot clients and multiple AI-Chatbot servers for leveraging an ensemble of AI-chatbots and modules with relatively diverse expertise in different domains.

An SVAOA Manager may, in some approaches, be a user interface for allowing administrators and users to configure and customize SVAOA settings, e.g., authentication of AI chatbot servers, authorized IoT networks, etc., attributes of the SVAOA, and/or SVAOA criteria, e.g., predefined threshold of trustworthiness for dynamically calculating the expertise score, AI ChatbotSelectionList [Domain], etc. Furthermore, an SVAOA Service Profile may, in some approaches, be a configuration file for saving an administrator's configured SVAOA settings, SVAOA criteria, e.g., a predefined threshold of trustworthiness for dynamically calculating the expertise score, an AIChatbotSelectionList [Domain], etc., and/or the SVAOA Data Structure. The SVAOA Data Structure may be a data structure with related algorithms for verifying and evaluating returned AI chatbot answers, and ranking the multiple AI chatbots in the predetermined categories. For example, these rankings may be determined based on, e.g., SVAOA_Data (BotID, Question, Answer, Relevance-Consistency (RC), Domain, CurrentExpertiseScore (ES1), UpdatedExpertiseScore (ES2), BestAnswer, etc.

The SVAOA Criteria may define a set of algorithms and/or service rules for verifying and evaluating the multiple AI chatbots and/or modules. For instance, the SVAOA criteria may include a predefined threshold (TH) of trustworthiness for determining a relevance consistency (RC) value of each returned response, and dynamically calculating the expertise score of each AI chatbot in the AI ChatbotSelectionList [Domain]. An administrator may define a set of universal SVAOA criteria and save them into a server profile. Furthermore, in some approaches, each user may customize a part of the criteria and save the customized criteria into a user profile. For instance, a default threshold defined by an administrator may be “50%” for all domains, but a first user may request that the threshold be changed to “65%” for the domain “Computer Programing” in order to determine a best computer programming AI Chatbot and/or in a predetermined programming language.

The Domain Determination Agent may be a module for determining the domain of a given request. In some approaches, the agent may use an NLP application programming interface (API) to determine, for example, whether a user request is in a “computer program” domain, or a “travel geography” domain. The AI-Chatbot Selector may be a module configured to select a set of AI-Chatbots with relatively higher expertise scores. The SVAOA Requester may, in some approaches, be a module for sending a user request to the selected AI-Chatbots from the SVAOA Server. Furthermore, the SVAOA Receiver may be a module for receiving, e.g., obtaining, a set of answers from the selected AI-Chatbots. The SVAOA Analyzer is, in some approaches, a module for analyzing the obtained answers to determine the relevance consistency according to a predetermined similar/different answer determination comparison technique. The SVAOA Analyzer may be caused to set the Relevance Consistency subsequent to making such a determination. The infrastructure 300 additionally and/or alternatively includes an Expertise Score Calculator that may be a module for recalculating each expertise score for each of the participating AI chatbots, and prioritizing the AIChatbotSelectionList [Domain] based on the updated scores.

A Best Answer Identifier may be a module for identifying the relatively best answer according to the determined relevance consistency. An SVAOA Adjuster may be a module for adjusting the SVAOA Criteria and related settings according to feedback obtained on or from a user device. For instance, assuming that a user is not satisfied with a determined and returned “best answer”, the user device may be provided all of the answers to allow manual inspection of the answers. The SVAOA Adjuster may be configured to adjust the expertise scores according to the user adjusted “best answer”.

The ChatBot Servers include a set of AI chatbot servers (or single Chatbot server with multiple large language modules) collected by administrators and/or users so that the SVAOA server can send a user request to the set of AI chatbot servers in order to receive multiple answers. Furthermore, the SVAOA client is a plugin and/or application which may be installed in an application/application level for leveraging an ensemble of AI chatbots and modules with diverse expertise in different domains. The SVAOA Monitor is a module for monitoring a human computer interactions, e.g., sent requests, received answers, satisfactions, feedback, etc., in a SVAOA client side (web Browser). The monitored information may, in some approaches, be integrated into the SVAOA data structure and passed to the SVAOA server. Finally, the SVAOA Render is, in some approaches, a module for rendering the returned best answer for a SVAOA client.

Now referring to FIG. 4, a flowchart of a method 400 is shown according to one embodiment. The method 400 may be performed in accordance with the present invention in any of the environments depicted in FIGS. 1-6, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

For context, method 400 may be performed in a network environment, e.g., such as the network environment described in method 200. In some approaches, the network environment includes a first user device, e.g., see SVAOA Client, which is configured to interact with a user (see “User”), such as via a text entry input display component of the first user device. Furthermore, in some approaches, the first user device may include an AI-Chat Interface, e.g., web browser, which is configured to host human computer interactions, e.g., text entry input in the form of an AI chatbot request. A SVOA monitor component of the first device may be caused, e.g., instructed, the monitor and record these human computer interactions. For context, operations of method 400 define techniques of a SVAOA enabled with aggregated multiple AI chatbots in a human computer interaction (HCI) level for leveraging an ensemble of AI chatbots and modules with diverse expertise in different domains.

Method 400, in some approaches, includes defining an SVAOA framework for empowering AI chat trustworthiness and accuracy. In some approaches, this framework includes a first user device, e.g., the SVAOA Client. Furthermore, this framework may include a server, e.g., see SVAOA Server, which is configured to interact with the first user device and at least one chatbot server, e.g., see ChatBot Servers Bot1, Bot2, Boti, and BotN. Method 400 may additionally and/or alternatively include defining a special SVAOA data structure with related algorithms for verifying and evaluating returned AI-Chatbot answers, and ranking the multiple AI-Chatbots in the predetermined categories. A plugin and/or application may additionally and/or alternatively be defined which may be installed on one or more levels of an application, application web browsers, AI chatbot applications, etc., for sending a single request to multiple AI chatbots and receiving the best answer from a set of returned answers from the multiple AI chatbots and/or trained modules, e.g., SVAOA client.

In some approaches, administrators and/or users may be allowed to configure and/or customize SVAOA settings (Authentication of AI-Chabot Servers, Authorized IoT Networks), attributes of the SVAOA, SVAOA criteria (predefined threshold of trustworthiness for dynamically calculate the expertise score, AI-ChatbotSelectionList [Domain]), etc., based on input received on the first user device.

Method 400 includes causing monitoring of human computer interactions to be performed, e.g., sent requests, received answers, satisfactions, feedback, etc., on the SVAOA Client Side (web Browser). The monitored information may be integrated into the SVAOA data structure and passed to and received by the SVAOA server, e.g., see To Domain Determination Agent. The Domain Determination Agent of the SVAOA server may be caused to determine a domain associated with a chatbot question of the request. In some approaches, a set of AI chatbots with relatively higher expertise scores of the determined domain are identified by an AI chatbot selector component. In some approaches, the AI chatbot selector component may be configured to select at least some of the AI chatbots based on user preferences that are determined by an SVAOA manager component of the SVAOA server. In some approaches, the SVAOA manager component is configured to store information that may be used to determine these user preferences, e.g., see SVAOA criteria, user profiles, SVAOA data table, and SVAOA service profile. These preferences may be adjusted at any time, e.g., see SVAOA adjuster, such as in response to receiving an instruction from an administrator component and/or in response to receiving updated preferences from the first user device.

The user request is sent to the selected AI chatbots from the SVAOA server via an SVAOA requester component in some approaches. A set of potential answers are received from the selected AI chatbots by the SVAOA receiver. The potential answers are analyzed by an SVAOA analyzer component to determine a “best answer”. Techniques described elsewhere herein for determining domain expertise scores of the AI chatbots may be used. In some approaches, these determinations may include recalculating updated expertise scores using current expertise scores for each of the AI chatbots that determined one of the potential answers. An expertise score calculator may be used to make these calculations and/or prioritize the updated expertise scores. In some approaches, the recalculations do not identify a relatively highest prioritized answer, e.g., see “Yes” logical path of the “Prioritizing” decision return to the selection list. In such approaches, additional potential answers are optionally obtained from different determined AI chatbots. In contrast, in response to a relatively highest prioritized answer being determined, e.g., see “No” logical path of the “Prioritizing” decision, the identified answer is provided to the first user device, e.g., see “To SVAOA Render”. In some approaches, the identified answer is rendered for the first user device.

In some approaches, the SVAOA criteria and related settings may be adjusted according to feedback that is received, e.g., see SVAOA Adjuster and Feedback.

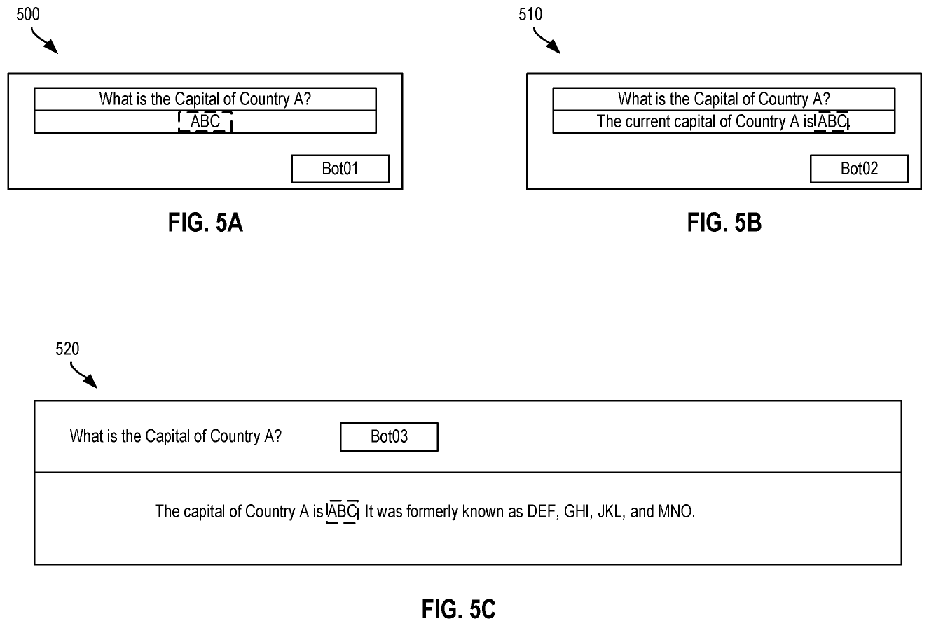

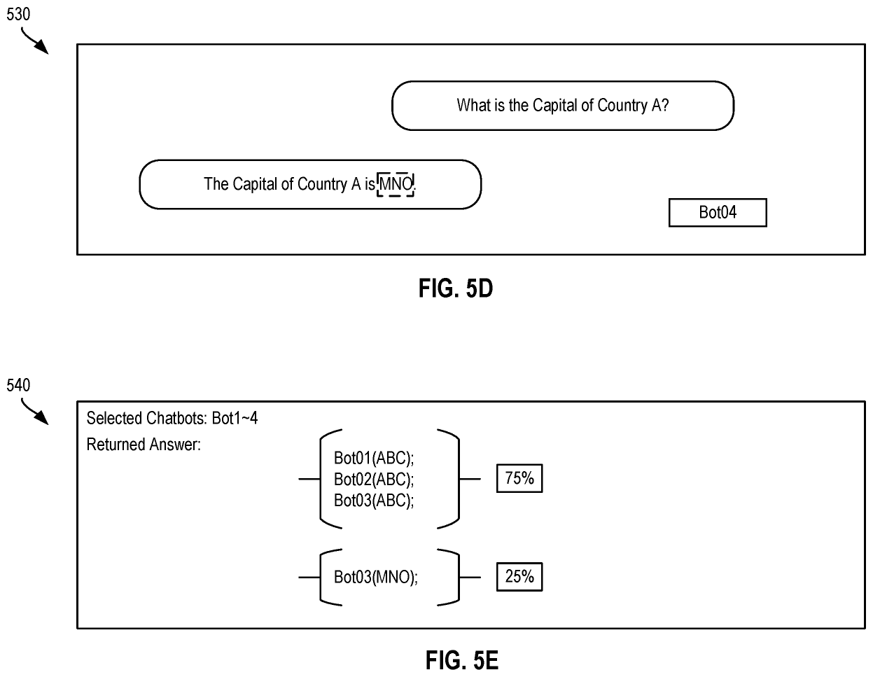

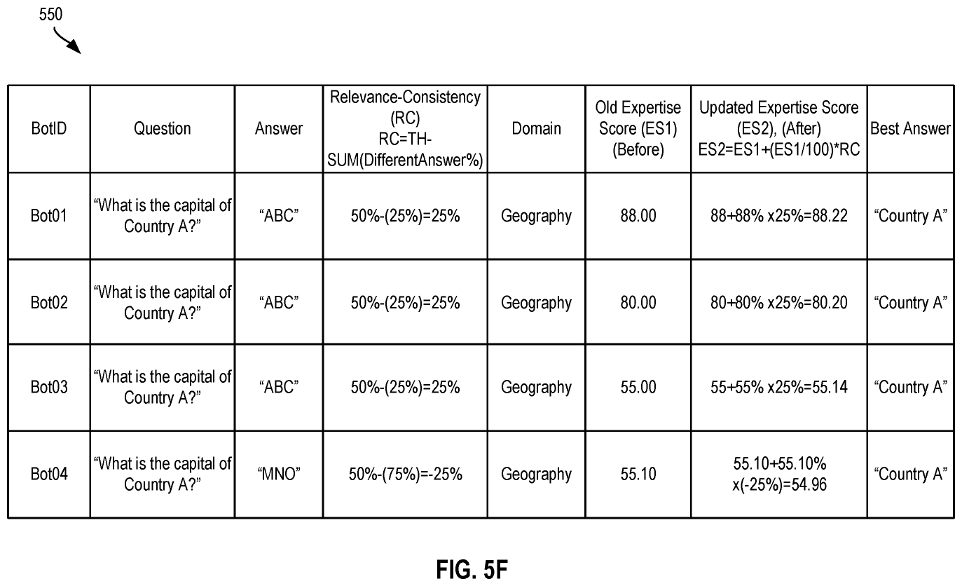

FIGS. 5A-5F depict snapshots 500-550 of the progression of an analysis of potential answers generated by AI chatbots, in accordance with one embodiment. As an option, the present snapshots 500-550 may be implemented in conjunction with features from any other embodiment listed herein, such as those described with reference to the other FIGS. Of course, however, such snapshots 500-550 and others presented herein may be used in various applications and/or in permutations which may or may not be specifically described in the illustrative embodiments listed herein. Further, the snapshots 500-550 presented herein may be used in any desired environment.

Referring now to FIG. 5A, a first snapshot 500 includes a first answer to a chatbot question, where the first answer is generated by a first AI chatbot, e.g., see Bot01. The chatbot question requests that the AI chatbot answer what the capital of a country is, e.g., Country A. The first answer attests that the capital of a country A is “ABC”. Similarly, in FIG. 5B, a second snapshot 510 includes a second answer to the chatbot question, where the second answer is generated by a second AI chatbot, e.g., see Bot02. The second answer also attests that the capital of the country A is “ABC”. Furthermore, in FIG. 5C, a third snapshot 520 includes a third answer to the chatbot question, where the third answer is generated by a third AI chatbot, e.g., see Bot03. The third answer also attests that the capital of the country A is “ABC”, but recognizes that the capital was formerly known as “DEF”, “GHI”, “JKL”, and “MNO”. Referring now to FIG. 5D, a fourth snapshot 530 includes a fourth answer to the chatbot question, where the fourth answer is generated by a fourth AI chatbot, e.g., see Bot04. In contrast to the other answers, the fourth answer attests that the capital of the country A is “MNO”.

The answers may be analyzed using techniques described herein to determine a best one of the answers. For example, referring to FIG. 5E, the fifth snapshot includes a breakdown of the selected answers. The breakdown recognizes that 75% of the answers match one another, while the remaining 25% of the answers do not match with any of the other answers. This breakdown may, in some approaches, be used to determine relevance-consistency values of the answers, and expertise scores of the different AI chatbots, as will now be described in FIG. 5F.

Referring now to FIG. 5F, the snapshot 550 includes a table of information that may be used to determine a best one of the answers. More specifically, the information of the breakdown in snapshot 540 may be used to determine relevance-consistency values using Equation (1) which is described elsewhere herein and shown in the snapshot 550. Furthermore, old expertise scores (ES1) may be used to determine updated expertise scores (ES2) using Equation (1) which is described elsewhere herein and shown in the snapshot 550. Thereafter, in some preferred approaches, the answer generated by the AI chatbot having the relatively highest updated first domain, e.g., see Geography, expertise score may be selected to be provided to a first user device. For example, in the snapshot 550 the AI chatbot having the relatively highest updated first domain score is Bot01, e.g., see 88.22. Accordingly, the answer “Country A” generated by the first AI chatbot is caused to be returned to the first AI chatbot. In some other approaches, the best answer may be determined to be generated by the AI chatbot having an expertise score that has increased in a predetermined manner, e.g., the only expertise score that has increased as a result of being updated, the expertise score that has increased relatively most as a result of being updated, etc.

It should be noted that although the fourth answer generated by the fourth AI chatbot is shown to be relatively inaccurate when compared to the other answers, in some approaches, techniques described herein may selectively include an active tuning up feature that takes user requests to manually tag an indicated answer of the plurality of candidate answers as the “best answer”. For example, in the snapshot 550, the 75% value of the fourth AI chatbot may be changed a predetermined amount, e.g., to 0%, in response to receiving such a user request. In other words, in some cases, a user may not think that the answer provided to the first user device is correct. In response thereto, user feedback may be received that may be used to reverse the calculated expertise scores. For instance, in one approach, a user may believe that the selected and returned answer “ABC” is incorrect, and therefore provide user feedback that the answer “MNO” is in fact correct. In response to receiving such feedback, a sum of correction may be changed from 70% to 0%. The relevance-consistency would then be RC=50%−(0%)=25%, and the updated expertise score (ES2) for Bot4 would then be 55.10+55.10%×(25%)=68.88%. It should be noted that, depending on the approach, the calculated expertise scores of other bots scored may be recalculated and reduced as well.

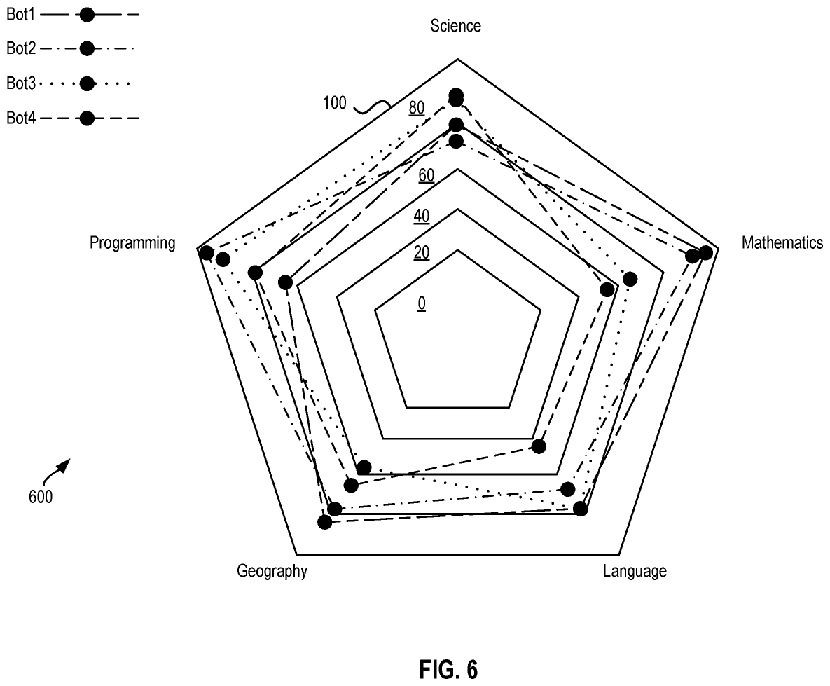

FIG. 6 depicts a distribution 600 of different expertise scores of different AI chatbots, in accordance with one embodiment. As an option, the present distribution 600 may be implemented in conjunction with features from any other embodiment listed herein, such as those described with reference to the other FIGS. Of course, however, such distribution 600 and others presented herein may be used in various applications and/or in permutations which may or may not be specifically described in the illustrative embodiments listed herein. Further, the distribution 600 presented herein may be used in any desired environment.

The distribution 600 includes a plurality of respective expertise scores for different AI chatbots, e.g., see Bot01, Bot02, Bot03, and Bot04, across a plurality of different expertise domains, e.g., see Programming, Science, Mathematics, Language and Geography. The expertise scores are plotted within different score ranges of the distribution 600, e.g., see 0, 20, 40, 60, 80 and 100, where the points of the pentagon are associated with an expertise score of 100. The distribution 600 illustrates how different AI chatbots can have different degrees of expertise in different expertise domains. These expertise scores may be dynamically updated over time, e.g., as the AI chatbots evaluate and answer different chatbot questions.

Several use case examples of the techniques described herein being applied to select an answer from a plurality of candidate answers are described below.

In a first use case example, a general knowledge question may be based on the user input of “What is the capital of France?”. The chatbot question may be sent to AI Chatbots A, B, and C, which are determined to have at least a predetermined threshold general knowledge domain expertise score. The self-verification algorithms described herein may be used to evaluate the answers generated by the AI chatbots to identify that AI chatbots A and B provide the same accurate answer “Paris”. Accordingly, one of the answers generated by the AI chatbots A and B may be selected for providing to a user device.

In a second use case example, a biological question may be based on the user input of “Explain the process of photosynthesis in plants.” The chatbot question here is in the form of an instruction, which may be sent to AI Chatbots A, B, and C, which are determined to have at least a predetermined threshold biological domain expertise score. The self-verification algorithms described herein may be used to evaluate the answers generated by the AI chatbots to identify that AI chatbot C provides an answer that includes a relatively more detailed and accurate explanation of photosynthesis than the answers of the other AI chatbots. Accordingly, the answer generated by the AI chatbot C may be selected for providing to a user device based on the AI chatbot C having a specialization in genetics and molecular biology.

In a third use case example, user feedback and a continuous learning question may be received. An answer may be selected from a plurality of potential answers generated by different AI chatbots, and the selected answer may be provided to a user device. Thereafter user feedback on the accuracy and relevance of the selected chatbot response may be received. This feedback may be used to improve the self-verification and answer optimization algorithms that were used to determine the selected answer. This relatively enhances the quality of future responses.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining a plurality of answers to a chatbot question, wherein the answers are generated by different artificial intelligence (AI) chatbots;
analyzing the answers to determine updated first domain expertise scores of the AI chatbots;
selecting, based on the updated first domain expertise scores, one of the answers; and
causing the selected answer to be provided to a first user device.

2. The computer-implemented method of claim 1, comprising: prioritizing the answers in a list based on the updated first domain expertise scores, wherein the selected answer is selected based on having the relatively highest updated first domain expertise score in the list.

3. The computer-implemented method of claim 1, wherein each of the AI chatbots have a plurality of expertise scores for a plurality of different domains, wherein the plurality of different domains include the first domain.

4. The computer-implemented method of claim 3, wherein the domains are selected from the group consisting of: geography, language, mathematics, science and programming.

5. The computer-implemented method of claim 1, comprising:
evaluating the chatbot question for determining a domain associated with the chatbot question, wherein the first domain is determined to be associated with the chatbot question during the evaluation;
selecting the AI chatbots from a pool of candidate AI chatbots, wherein the AI chatbots are selected in response to a determination that the AI chatbots currently have first domain expertise scores that exceed a predetermined threshold; and
causing the chatbot question to be sent to servers associated with the selected AI chatbots.

6. The computer-implemented method of claim 1, wherein analyzing the answers to determine the updated first domain expertise scores of the AI chatbots includes:
calculating relevance-consistency values for each of the answers,
wherein each relevance-consistency value indicates an extent of similarity that a given one of the answers has with the other answers,
wherein each relevance-consistency value is a difference of a predetermined threshold value and sum different answer values,
wherein the sum different answer value characterizes, for a given one of the answers, a percentage of the answers that the given answer differs from.

7. The computer-implemented method of claim 6, wherein the updated first domain expertise score of a given one of the AI chatbots is calculated as a sum of a first predetermined variable and a second predetermined variable, wherein the first predetermined variable is a current first domain expertise score of the given AI chatbot, wherein the second predetermined variable is a product of the current first domain expertise score of the given AI chatbot and the calculating relevance-consistency value of the given AI chatbot.

8. The computer-implemented method of claim 1, wherein causing the selected answer to be provided to the first user device includes: rendering the selected answer according to a predetermined sentence structure, and outputting the rendered selected answer to the first user device.

9. The computer-implemented method of claim 8, comprising:
receiving feedback about the rendered selected answer;
determining whether the feedback is positive feedback; and
in response to a determination that the feedback is not positive feedback,
decreasing, a predetermined amount, the updated first domain expertise
score of the AI chatbot that generated the selected answer.

10. A computer program product, the computer program product comprising a computer readable storage medium having program instructions embodied therewith, the program instructions readable and/or executable by a computer to cause the computer to:
obtain a plurality of answers to a chatbot question, wherein the answers are generated by different artificial intelligence (AI) chatbots;
analyze the answers to determine updated first domain expertise scores of the AI chatbots;
select, based on the updated first domain expertise scores, one of the answers; and
cause the selected answer to be provided to a first user device.

11. The computer program product of claim 10, the program instructions readable and/or executable by the computer to cause the computer to: prioritize the answers in a list based on the updated first domain expertise scores, wherein the selected answer is selected based on having the relatively highest updated first domain expertise score in the list.

12. The computer program product of claim 10, wherein each of the AI chatbots have a plurality of expertise scores for a plurality of different domains, wherein the plurality of different domains include the first domain.

13. The computer program product of claim 12, wherein the domains are selected from the group consisting of: geography, language, mathematics, science and programming.

14. The computer program product of claim 10, the program instructions readable and/or executable by the computer to cause the computer to:
evaluate the chatbot question for determining a domain associated with the chatbot question, wherein the first domain is determined to be associated with the chatbot question during the evaluation;
select the AI chatbots from a pool of candidate AI chatbots, wherein the AI chatbots are selected in response to a determination that the AI chatbots currently have first domain expertise scores that exceed a predetermined threshold; and
cause the chatbot question to be sent to servers associated with the selected AI chatbots.

15. The computer program product of claim 10, wherein analyzing the answers to determine the updated first domain expertise scores of the AI chatbots includes:
calculating relevance-consistency values for each of the answers,
wherein each relevance-consistency value indicates an extent of similarity that a given one of the answers has with the other answers,
wherein each relevance-consistency value is a difference of a predetermined threshold value and sum different answer value,
wherein the sum different answer value characterizes, for a given one of the answers, a percentage of the answers that the given answer differs from.

16. The computer program product of claim 15, wherein the updated first domain expertise score of a given one of the AI chatbots is calculated as a sum of a first predetermined variable and a second predetermined variable, wherein the first predetermined variable is a current first domain expertise score of the given AI chatbot, wherein the second predetermined variable is a product of the current first domain expertise score of the given AI chatbot and the calculating relevance-consistency value of the given AI chatbot.

17. The computer program product of claim 10, wherein causing the selected answer to be provided to the first user device includes: rendering the selected answer according to a predetermined sentence structure, and outputting the rendered selected answer to the first user device.

18. The computer program product of claim 17, the program instructions readable and/or executable by the computer to cause the computer to:
receive feedback about the rendered selected answer;
determine whether the feedback is positive feedback; and
in response to a determination that the feedback is not positive feedback,
decrease, a predetermined amount, the updated first domain expertise
score of the AI chatbot that generated the selected answer.

19. A system, comprising:
a processor; and
logic integrated with the processor, executable by the processor, or integrated with and executable by the processor, the logic being configured to:
obtain a plurality of answers to a chatbot question, wherein the answers are generated by different artificial intelligence (AI) chatbots;
analyze the answers to determine updated first domain expertise scores of the AI chatbots;
select, based on the updated first domain expertise scores, one of the answers; and
cause the selected answer to be provided to a first user device.

20. The system of claim 19, the logic being configured to: prioritize the answers in a list based on the updated first domain expertise scores, wherein the selected answer is selected based on having the relatively highest updated first domain expertise score in the list.
